(19) United States
(12) Patent Application Publication
(10) Pub. No.: US 2026/0364913 A1
(43) Pub. Date: Nov. 19, 2026

(54) Method of Reinforcing a Corrugated Container

(71) Applicant: Wilhelm Kullberg, Sacramento, CA (US)

(72) Inventor: Wilhelm Kullberg, Sacramento, CA (US)

(21) Appl. No.: 18/831,675

(22) PCT Filed: Jan. 16, 2024
(86) PCT No.: PCT/US2024/011564

§ 371 Date: Jul. 16, 2025

(30) Foreign Application Priority Data
Jan. 18, 2023 (GB) 2300706.5
Mar. 19, 2023 (GB) 2303982.9
Mar. 20, 2023 (GB) 2304054.6

(51) Int. Cl. B31B 50/81; B31B 50/20; B31B 120/40; B65D 5/44

(52) U.S. Cl. CPC B31B 50/81; B31B 50/20; B65D 5/443; B31B 2120/40

(57) ABSTRACT

A method of reinforcing a standard regular slotted, top loaded corrugated container having an outside and an inside linerboard layer with a fluted or corrugated medium layer glued in between both outer linerboard layers, characterized in that three paper patches glued onto the inside or the outside linerboard of the container board web sheet.

### BACKGROUND OF THE INVENTION

Reducing packaging raw material is important for preserving our future environment. The present invention reduces material consumption by up to 30% by enhancing the corrugated case top compression & side panels impact strength. A regular slotted corrugated (top loaded) container is made of up to 100% recyclable and biodegradable materials. A single wall corrugated container board has an outer and an inner kraft paper linerboard with a medium flute (corrugated) kraft paper linerboard layer between the two kraft paper linerboards. According to the present invention, three kraft paper patches (3-4% of the container boards total kraft paper webs sheets area) each glued onto the inside or outside linerboard of the container board web sheet, overlapping the upper & lower top & bottom horizontal panel flaps, arising from the container sleeves surrounding folding line and furthermore overlapping the container boards corner panels top & bottom sections after the container board top & bottom sections including the kraft paper patches slotted in a next manufacturing station with the 5^{th} panel of the 4^{th} panel corner glued and with the container panels folded to a finished container. Only three corners of a regular slotted corrugated container require reinforcement as the 4^{th} corner is already reinforced by containers 5^{th} panel's corrugated board overlapping panel. A 4^{th} reinforced paper corner patch is optional. First, glue is applied by the Flexographic printing press method onto the inner or outer kraft paper linerboard layer of the container board web sheet with generally identical glue pattern to the kraft paper patch and position to and for the kraft paper patch to be applied by compression in a continuing production station, following. One low capacity and affordable kraft paper patch cut-off & delivery method is feeding a kraft paper web from a roll by dual feeding rollers, stopping the kraft paper web at the required kraft paper patch length and with a serrated cutting blade, cutting the kraft paper web to the correct patch length with multiple connecting linerboard web bridges not cut-off, keeping the perforated kraft paper web connected and securely feeding the next linerboard patch without being jammed. A stationary non-jam kraft paper web guide between each feeding roller starting below the outer roller periphery, exceeding the outer feeding roller periphery after about 60°-90°. Because the kraft paper patches are connected by multiple minor linerboard web bridges across the entire kraft paper web width the connected kraft paper patches (web) can be transferred into (require small diameter transfer rollers) the rotating vacuum drum, delivering each kraft paper patch onto the continuous moving inner or outer linerboard container board web sheet. A 25 mm diameter drive shaft having ball bearings between every group of two or three dual kraft paper feeding & vacuum drum transfer rollers with a 45 mm diameter concentric sleeves design connected onto a 25 mm diameter drive shaft by concentric space sleeves between each concentric drive roller, secured to the 25 mm drive shaft both ends by double slotted disc springs. The dual web feeding & vacuum drum transfer concentric drive rollers having a straight knurled surface drive pattern including multiple linear micro teeth profiled top arc panels across & around the outer periphery with a smooth circular surface. The serrated cutting blade below the dual feeding roller is operated by a crank shaft, driven by a stepper motor. After the kraft paper webs perforation line exit the vacuum drums dual feeding rollers, one kraft paper patch is being ripped off from the kraft paper web by the vacuum drum with the kraft paper patch following around the rotating vacuum drums surface, compressing the kraft paper patch and sealed by the glue area onto the continuous moving outer linerboard surface of the container board web sheet. The vacuum drum is turning continuously. The vacuum drum does not have a perforated vacuum section across the entire drum width, but 4-6 perforated circular vacuum lane panels around the drum surface connected to a bearing sleeve in the center with the ball bearing turning around an inner stationary non-rotating shaft with the stationary shaft in the center attached to the vacuum blocking bracket, eventually one for each vacuum lines (side view of section FIG. 3). A second, high capacity kraft paper web cut-off & delivery method is a servo motor powered by a servo drive connected to a microprocessor, driving & positioning the driving shaft with a serrated cutting blade which require the serrated cutting blade rotating on a larger circular path. The shaft with the serrated blade should operate in an epicycle having lowest speed coordinated with the kraft paper web speed during the perforating moment when the serrated blade is perforating the kraft paper web, entering the dual roller's anvil grove. The serrated perforation roller having protruding elastomer compression cushions on both sides of the serrated perforation blade with the elastomer cushions forehead slightly raised slightly above that the multiple serrated cutting blade edge tips, keeping the kraft paper web in a firm position during perforation. Two kraft paper roll web widths will cover all container sizes as the kraft paper patched is not required to reach the container sleeves both edges precisely. In principle, only the corrugated containers folding lines for the top and bottom panels needs to be overlapped by the kraft paper patches. The kraft paper patch cycle starts with parts of the correct kraft paper patch length sliding on the rotating vacuum drum after having been perforated by the serrated cutting blade and is in “hold” position by the dual vacuum drum web transfer rollers. The kraft paper patch is launched when the webs perforation line exits the vacuum drums dual web patch transfer rollers, releasing the entire kraft paper patch onto the rotating vacuum drum with the vacuum drum turning, delivering & compressing the kraft paper patch precisely onto the glued area on the moving outer linerboard of the container web sheet. If the kraft paper patch does not match the glue mark on the paper patched after glued onto the corrugated container web sheet, the glue which could have different color than the linerboard web appears outside the kraft paper patch area and a color registration mark sensor send reference signals to a microprocessor with the servo controller, adjusting the servo motor serrated blade position and correcting the kraft paper patch launching time for additional kraft paper patches. A non-stick stationary Teflon glue scraper and a rotating nylon brush with a vacuum cleaner for removing residue glue from any continuing rollers might be redundant with a precise position glue pattern. A third kraft paper patch application method will unfortunately reduce the machines production speed is picking up kraft paper patches one by one from a stack of already finished cut to size kraft paper patches. A suction device picking up a linerboard patch from the top of the linerboard patch stack with the rotating suction device rotating around a second outer circular periphery, coordinated with same speed as the contentiously mowing corrugated container board web sheet, delivering & placing the kraft paper patch precisely onto the glue pattern printed on the continuously mowing outer linerboard of the container board web sheet. Two automatically exchangeable kraft paper patch-trays with a stepper motor driving the patch-trays lower floor up & down, controlled by a photoelectric sensor, controlling that the upper kraft paper patch level always having the same position.

### SUMMARY OF THE INVENTION

Accordingly, it is an object of the present invention to obviate the above noted, shortcomings & disadvantages related to known reinforce methods for corrugated containers in the prior art.

It is another objective of the present invention to provide a corrugated container with reduced paperboard weigh which will be more economical.

It is furthermore another objective of the present invention to provide a corrugated container which will reduce consumption of natural resources.

### BRIEF DESCRIPTION OF THE DRAWINGS

FIG. 1 is an isometric view of a corrugated container with linerboard patched around the vertical outside corners of the corrugated container, overlapping the horizontal top & bottom panel edges of the corrugate container.

FIG. 2 is a side view of the rotating glue applicator, applying glue spots onto the inner or outer linerboard layer of the corrugated container board sheet with generally identical glue pattern and position to and for the kraft paper linerboard patches to be applied in a continuing manufacturing process.

FIG. 3 is a side view of one manufacturing method of cutting off a kraft paper patch and applying the kraft paper patch by a vacuum drum to a continuous moving corrugated container board web sheet outer kraft paper linerboard.

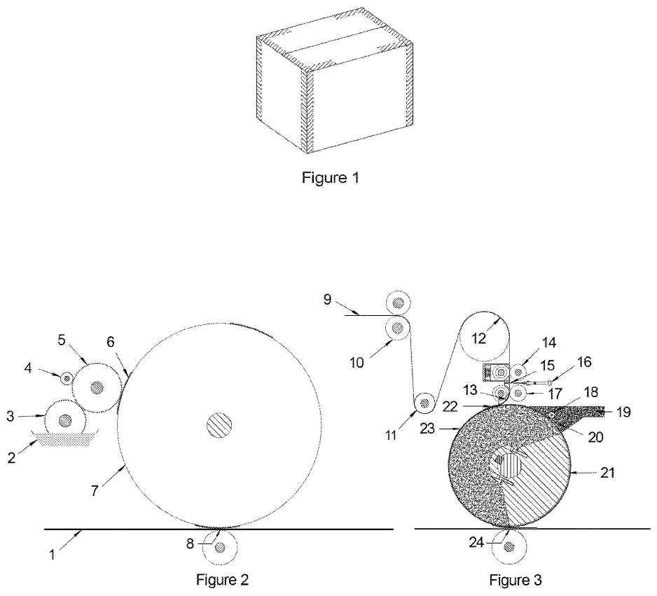

### DESCRIPTION OF THE PREFERRED EMBODIMENT

According to FIG. 2 is a side view of the Flexographic glue application printing unit, printing a glue pattern onto the inner or outer linerboard of the container board web sheet 1. From glue tray 2, fountain roller 3 picking up a layer of glue when turning, delivering the glue layer to turning Anilox roller 5, with turning metering roller 4, providing an evenly glue layer to Flexographic plate 6, secured to plate cylinder 7, turning and transferring the glue pattern onto the linerboard of the container board web sheet 1 by impression cylinder 8.

According to FIG. 3 is a side view of one simple kraft paper patch application unit. Kraft paper web 9 is fed by dual feeding rollers 10, operated by dancer bar 11. Kraft paper web 9 is following main feeding roller 12 into dual kraft paper web feeding rollers 14 having an anti-slip outer web gripping surface, supplying the continues kraft paper web with support from dual vacuum drum kraft paper transfer rollers 17, until halted by a stepper motor or an electromagnetic coupling, with the precise kraft paper patch length cut-off by a serrated cutting blade 15, driven by crank shaft 16 with <5 mm stroke length. Stationary non-jamming kraft paper web guide 13 is oriented between each feeding roller, starting below the outer roller periphery exceeding outer feeding roller periphery after about 60°-90° in web feeding direction. Kraft paper patch 22, still attached to the kraft paper web by multiple minor kraft paper web connecting bridges, sliding around rotating vacuum drum 23 until the end of the kraft paper patch 22 exiting dual vacuum drum kraft paper transfer rollers 17 with the kraft paper web connecting bridges being ripped off and the kraft paper patch 22 firmly attached onto rotating vacuum drum 23. Rotating vacuum drum 23 vacuum supply from outside the drum periphery by non-rotating vacuum manifold 19 with rotating vacuum drum 23 vacuum being blocked by inside the drums non-rotating vacuum blocking bracket 21. As the kraft paper patch 22 moving around with vacuum drum 23, merging onto the continuous mowing container board web sheet, compressed & attached by the glue to the continuous moving outer linerboard of the container board web sheet by impression cylinder 24. Non-rotating vacuum blocking bracket 21, blocking vacuum in the perforated vacuum drum surface and releasing the kraft paper patch 22 from the rotating drum and attaching the kraft paper patch 22 onto the outer linerboard of the corrugated board web sheet by impression cylinder 24. Rotating nylon brush 18 and stationary Teflon scraper 20, releasing residue glue from the rotating vacuum drum surface and being picked up by vacuum supply line 20.

The present invention should not be considered limited to the examples described above, but rather should be understood to cover all aspects equivalent methods and processes as well as numerous structures to which the present invention may be applicable, will be readily apparent to those of skilled in the art, to which the present invention is directed upon review of the instant specification.

1. A method of reinforcing a standard regular slotted (top loaded) corrugated container having an outside and an inside linerboard layer with a fluted (corrugated) medium layer glued in between both outer linerboard layers, characterized in that three paper patches glued onto the inside or the outside linerboard of the container board web sheet, each said paper patch overlapping the container board sleeve's upper & lower surrounding folding lines for the containers horizontal top & bottom panel flaps and furthermore the same three said paper patches overlapping three container boards sleeve's corner panels sections after implementing creasing/folding lines & slotted in a next machine station with the 5^{th} panel of the 4^{th} panel corner glued and the container sleeve opened with the container panels folded to a finished container in furthermore separate operations.

2. A method of reinforcing a standard slotted (top loaded) corrugated container according to claim 1, characterized in that the multiple connecting paper patches have a perforation line between each other, said perforation line having several non-cut web bridges, said paper non-cut web bridges being ripped off before, or during attachment of the separate paper patch to said continuous moving outer linerboard of the containerboard web sheet.

3. A method of reinforcing a standard slotted (top loaded) corrugated container according to claims 1 & 2, characterized in that both upper & lower horizontal end panel sections arising from the container end panels, horizontal surrounding folding line, including the paper patch split in two with the folded & finished case having one part of said paper patch attached to a respective top & bottom side panel edge of one horizontal panels closure edge and the other part of said paper patch, attached to respective top & bottom side edge of the other horizontal panel edge.

4. A method of reinforcing a standard slotted (top loaded) corrugated container according to claim 1 & 3, characterized in that a paper patch is compressed & attached to the glue area of the moving inner or outer linerboard of the container board web sheet by a rotating vacuum drum.

5. A method of reinforcing a standard slotted (top loaded) corrugated container according to claims 1-4, characterized in that a servo motor driving a rotating shaft with a serrated perforation blade having multiple interrupted non-cutting paper web bridge sections, cutting perforation lines in a continuous moving said paper web against a rotating second anvil roller by said serrated perforation blade edge, overlapping said second rotating anvil rollers outer cylindrical periphery during the cutting moment with said serrated perforation blade edge entering a groove generally across said second rotating anvil roller in the cutting moment.

6. A method of reinforcing a standard slotted (top loaded) corrugated container according to claims 1-5, characterized in that a web is held between two dual intermittent operating rotating rollers in non-moving position with the serrated perforation blade between said serrated perforation blade having multiple interrupted non-cutting paper web sections, cutting a generally straight perforation line across the paper web perforation line against a permanent stationary slotted anvil.

7. A method of reinforcing a standard slotted (top loaded) corrugated container according to claim 1-6, characterized in that a paper patch is picked up one by one from a paper patch stack by a vacuum device, moved & attached to the glued area on a moving outer linerboard of a container board web sheet by the rotating said vacuum suction device.

8. A method of reinforcing a standard slotted (top loaded) corrugated container according to claims 1-7, characterized in that the glue pattern on the outer linerboard of the container board web sheet and the paper patch, generally having identical surface patterns.

9. A method of reinforcing a standard slotted (top loaded) corrugated container according to claims 1-8, characterized in that a moving compression force originate and is transferred from a rotating roller, compressing a paper patch against a moving inner or outer linerboard of the container board web sheet with a glue layer between.

10. A method of reinforcing a standard slotted (top loaded) corrugated container according to claims 1-9, characterized in that a color registration mark sensor register a printed color mark on a container board sheet, sending a registration signal to a microprocessor with a servo motor controller, positioning the paper web serrated rotating cut-off blade shaft, cutting a perforation line with a precise patch rip-off position, for the rotating vacuum drum to separate one paper patch from the paper web, and attaching the separate paper patch surface precisely on the glue mark printed on the moving container board sheet.

11. A method of reinforcing a standard slotted (top loaded) corrugated container according to claims 1-10, characterized in that the paper patch rotating perforated vacuum applicator drum turning around an outside non-rotating vacuum supply line and an inside said non-rotating vacuum blocking bracket.

12. A method of reinforcing a standard slotted (top loaded) corrugated container according to claims 1-11, characterized in that the rotating paper patch vacuum application drum is feed by a line of several identical dual feeding & transfer rollers having a protruding web guide & concentric distance spacers between said dual feeding & transfer rollers, respective said dual feeding & transfer rollers connected to and driven by one or two drive shafts.

13. A method of reinforcing a standard slotted (top loaded) corrugated container according to claims 1-12, characterized in that at least one glue scraper and at least one rotating Nylon brush, collecting residual glue from the rotating vacuum drum with a vacuum inlet/hose cleaner, removing said residual glue from said glue scraper and said rotating Nylon brush.

14. A method of reinforcing a standard slotted (top loaded) corrugated container according to claims 1-13, characterized in that the paper patch glue having a different color than the brown linerboard web, recognizable by a color registration mark sensor, discern the color difference between the paper patch glue and the linerboard web.

15. A method of reinforcing a standard slotted (top loaded) corrugated container according to claims 1-14, characterized in that the corrugated container having three or four overlapping reinforced paper patch corner sections, said corrugated container design might be different from a standard (top loaded) corrugated container design.

16. A method of reinforcing a standard slotted (top loaded) corrugated container according to claims 1-15, characterized in that a kraft paper patch is compressed & laminated by a force, originating & transferred by a rotating roller and attached by gluing to either side of any of the three continuous moving webs or web sheets.
